(19) United States
(12) Patent Application Publication
(10) Pub. No.: US 2006/0007074 A1
(43) Pub. Date: Jan. 12, 2006

(54) Image display apparatus and method of driving same

(75) Inventors: Shinya Ono, Yokohama-shi (JP); Yoshinao Kobayashi, Kanagawa (JP)

Correspondence Address: BIRCH STEWART KOLASCH & BIRCH, PO BOX 747, FALLS CHURCH, VA, 22040-0747, US

(73) Assignees: Kyocera Corporation, Kyoto-Shi (JP); Chi Mei Optoelectronics Corp., Tainan (TW)

(21) Appl. No.: 11/159,328

(22) Filed: Jun. 23, 2005

(30) Foreign Application Priority Data
Jun. 25, 2004 (JP) 2004-188834

(51) Int. Cl. G09G 3/30

(52) U.S. Cl. 345/76

(57) ABSTRACT

An image display apparatus includes a light emitting element that emits light depending on an injected electric current; a driver that includes at least a first terminal and a second terminal, and controls the light emitting element based on a potential difference, applied between the first terminal and the second terminal, of a level higher than a predetermined threshold; a storage capacitor that serves to retain a potential on the first terminal of the driver; and a controller that changes the potential on the first terminal via the storage capacitor at writing of electric data current corresponding to a display in a black level.

### BACKGROUND OF THE INVENTION

1. Field of the Invention

The present invention relates to an image display apparatus, and more particularly to an image display apparatus which allows improvement in response speed at data writing for a display in a black level without being affected by constraint in area per pixel.

2. Description of the Related Art

Conventionally, proposals have been made to realize an image display apparatus provided with organic light-emitting diodes (OLEDs) which emit light by recombination of positive holes and electrons injected into a light emitting layer.

FIG. 14 is a diagram of a structure of a pixel-circuit corresponding to one pixel in the conventional image display apparatus. The pixel circuit of FIG. 14 includes an OLED 1, a switching element 2, a driver element 3, a switching element 4, a switching element 5, a gate signal line 6, a gate signal line 7, a source signal line 8, an electroluminescent (EL) power source line 9, and a storage capacitor 1Cs. It should be noted that in a first part of the description on the conventional image display apparatus, the pixel circuit does not include a capacitor 1Ct (shown as surrounded by a broken line).

The OLED 1 has characteristics of emitting light when a potential difference equal to or higher than a threshold voltage is generated between an anode and a cathode to cause an electric current flow therein. Specifically, the OLED 1 includes at least an anode layer and a cathode layer formed from a material such as Al, Cu, and Indium Tin Oxide (ITO), and a light emitting layer formed from an organic material such as phthalcyanine, tris-aluminum complex, benzoquinolinolato, and beryllium complex, and functions to emit light by recombination of positive holes and electrons injected into the light emitting layer.

The switching elements 2, 4, and 5, and the driver element 3 are thin film transistors (TFT).

In the pixel circuit with the above-described structure, in a data writing period the switching elements 4 and 5 are turned ON whereas the switching element 2 is turned OFF. Then, when a programming electric current id is applied via the source signal line 8, the electric current i_{d} flows through a path formed by the EL power source line 9, the driver element 3, the switching element 4, and the source signal line 8 in this order. A gate potential V_{G} of the driver element 3 is determined according to the amount of the electric current i_{d} flowing along the source signal line 8. Thus, electric charges of an amount corresponding to the gate potential V_{G} are accumulated in the storage capacitor 1Cs.

In a light emitting period following the data writing period, the switching elements 4 and 5 are turned OFF whereas the switching element 2 is turned ON. Then, an electric current i_{d} of the same amount as the programming electric current applied in the data writing period flows through the OLED 1. If the amount of electric current id flowing through the source signal line 8 changes in the data writing period, the amount of electric charges accumulated in the storage capacitor 1Cs changes, thereby changing the amount of electric current i_{OL} in the light emitting period to change the luminance of the OLED 1.

When the OLED 1 performs an image display apparatus in a black level, for example, the amount of the electric current i_{d} flowing through the source signal line 8, i.e., an amount of an electric current for the black level display, is in the range of 1.5 nA to 29 nA. When the OLED 1 performs an image display apparatus in a white-level, the amount of the electric current i_{d} flowing through the source signal line 8, i.e., an amount of an electric current for the white level display, is approximately in the range of a few 100 nA to a few μA depending on an efficiency of the OLED 1, panel luminance, and resolution.

The display in the black level with a small programming electric current i_{d} causes rounding of the waveform of i_{d} due to a time constant defined by a resistance of the driver element 3 and a parasitic floating capacitance of the source signal line 8, whereby the amount of the electric current i_{d} does not reach a predetermined level immediately. To deal with this inconvenience, the conventional image display apparatus is required to have a long data writing period, resulting in a slow response speed.

To eliminate such inconvenience, the gate of the driver element 3 and the gate of the switching element 4 of FIG. 14 may be connected (capacitance-coupled) via the capacitor 1Ct (shown in broken line) to improve the response speed as is conventionally proposed.

With this proposed structure, in the data writing period the switching elements 4 and 5 are turned ON whereas the switching element 2 is turned OFF. Then, the electric current i_{d} flows into the source signal line 8. Specifically, the electric current i_{d} flows along a path formed by the EL power source line 9, the driver element 3, the switching element 4, and the source signal-line 8, in this order.

In the subsequent light emitting period, the switching elements 4 and 5 are turned OFF whereas the switching element 2 is turned ON. Then, because of the presence of the capacitor 1Ct, the gate potential V_{G} of the driver element 3 changes according to the potential variation on the gate signal line 6.

Variation ΔV_{G} of the gate potential V_{G} here can be represented as ΔV_{G}=ΔV_{gg}×(C_{gs}+Ct)/(C_{gs}+Ct+Cs) where C_{gs} represents a gate-to-source capacitance of the switching element 5. Here, Ct is a capacitance of the capacitor 1Ct, Cs is a capacitance of the capacitor 1Cs, and ΔV_{gg} is a variation in potential on the gate signal line 6.

At the transition from the data writing period to the light emitting period, the potential on the gate signal line 6 rises to increase the gate potential V_{G} of the driver element 3. The amount of increase varies according to the three values of capacitance. Since C_{gs} is determined based on the size and the structure of the switching element 5, elements that actually control the amount of increase are the capacitor 1Ct and the storage capacitor 1Cs.

Further, the increase in the gate potential of the driver element 3 causes the drain current decrease. The drain current of the driver element 3 drops by an amount corresponding to the variation ΔV_{G}. Hence, the amount of the electric current i_{OL} flowing through the OLED 1 is smaller than a predetermined amount when the switching element 2 is turned ON.

In other words, a larger amount of the electric current i_{d} than the predetermined amount is required to be applied to the transistor 3 in the data writing period in order to cause electric current flow of the predetermined amount in the OLED 1 in the light emitting period. The amount of the electric current i_{d} can be increased if the storage capacitor 1Cs is smaller or the capacitor 1Ct is larger.

When the storage capacitor 1Cs is smaller, the capacity to retain the electric charges decreases, which makes fluctuation in the gate potential V_{G} of the driver element 3 more likely. Thus, since the smaller storage capacitor 1Cs is not a realistic solution, the larger capacitor 1Ct is preferable.

When the amount of the electric current i_{d} flowing through the source signal line 8 increases, an apparent resistance of the driver element 3 can be reduced. Then, the time constant, which is a product of the resistance and the floating capacitance of the source signal line 8, decreases, to shorten the time required for the change of the electric current i_{d} to the predetermined amount in the data writing period, whereby the response speed can be improved.

FIG. 15 shows a relation between the electric current i_{d} flowing through the source signal line 8 and the electric current i_{OL} flowing through the OLED 1 at various capacitance values of capacitor 1Ct, provided that the amplitude of the gate signal line 6 is 14 V. If the capacitance ratio ((C_{gs}+Ct)/(C_{gs}+Ct+Cs)) is 0.03, the amount of the electric current i_{d} required to flow through the source signal line 8 is approximately five times the amount of the electric current i_{OL} flowing through the OLED 1. When the capacitance of 1Ct is further increased, the ratio of the electric current i_{d} flowing through the source signal line 8 to the electric current i_{OL} flowing through the OLED 1 rises. If the capacitance ratio is 0.8, the amount of the electric current i_{d} is 200 times the amount of the electric current i_{OL}, and if the capacitance ratio is increased up to 0.9, the amount of the electric current i_{d} is 500 times the amount of the electric current i_{OL}.

With the increase in the amount of the electric current i_{d} flowing through the source signal line 8, the resistance of the driver element 3 decreases, and the time required for the attainment of the predetermined amount of electric current is shortened. Hence, a higher capacitance of 1Ct results in more effective improvement of the response speed at data writing for the black level display.

The conventional technique as described above is disclosed, for example, in Japanese Patent Application Laid-Open No. 2003-140612.

As described above, in the conventional image display apparatus, a higher capacitance of 1Ct is more effective for the improvement of the response speed at data writing for the black-level display. The higher capacitance of 1Ct can be realized with a larger area of the capacitor 1Ct.

In the conventional image display apparatus, however, since there is a limit to an area usable for one pixel, the size of the capacitor 1Ct also is under a certain constraint. Hence, though the improvement in response speed is theoretically possible in the conventional image display apparatus, because of the actual manufacturing constraint, a remarkable improvement can hardly be achieved concerning the response speed at data writing for the black-level display.

### SUMMARY OF THE INVENTION

An image display apparatus according to one aspect of the present invention includes a light emitting element that emits light depending on an injected electric current; a driver that includes at least a first terminal and a second terminal, and controls the light emitting element based on a potential difference, applied between the first terminal and the second terminal, of a level higher than a predetermined threshold; a storage capacitor that serves to retain a potential on the first terminal of the driver; and a controller that changes the potential on the first terminal via the storage capacitor at writing of electric data current corresponding to a display in a black level.

According to the image display apparatus of the present invention, the potential on the first terminal is changed via the storage capacitor at writing of electric data current for the black-level display. Thus, the amount of electric current for data writing increases, and unlike the conventional image display apparatus, the improvement in the response speed at data writing for the black-level display can be achieved without being affected by the area constraint per pixel.

A method according to another aspect of the present invention is of driving an image display apparatus which includes a light emitting element, a driver electrically connected to the light emitting element, and a capacitor having a first electrode and a second electrode which is connected to a gate of the driver. The method includes controlling a potential on the gate by changing a potential on the first electrode of the capacitor at writing of electric data current corresponding to a display in a black level.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a circuit diagram of a pixel circuit corresponding to one pixel in an image display apparatus according to a first embodiment of the present invention, and FIG. 1B is a timing chart of the pixel circuit;

FIG. 2A is a diagram shown to describe a data writing operation in the first embodiment, and FIG. 1B is a timing chart of the pixel circuit in the data writing operation;

FIG. 3A is a diagram shown to describe a light emitting operation in the first embodiment, and FIG. 3B is a timing chart of the pixel circuit in the light emitting operation;

FIG. 4A is a diagram shown to describe a first phase of calculation of an average mobility parameter βₐᵥₑ in the first embodiment, and FIG. 4B is a timing chart of the pixel circuit in the first phase of the calculation;

FIG. 5A is a diagram shown to describe a second phase of calculation of the average mobility parameter βₐᵥₑ in the first embodiment, and FIG. 5B is a timing chart of the pixel circuit in the second phase of the calculation;

FIG. 6A is a diagram shown to describe a third phase of calculation of the average mobility parameter βₐᵥₑ in the first embodiment, and FIG. 6B is a timing chart of the pixel circuit in the third phase of the calculation;

FIG. 7A is a diagram shown to describe a fourth phase of calculation of the average mobility parameter βₐᵥₑ in the first embodiment, and FIG. 7B is a timing chart of the pixel circuit in the fourth phase of the calculation;

FIG. 8 is a graph of a relation between a electric data current i_{data} and an electric current i_{OLED} in the first embodiment;

FIG. 9A is a circuit diagram of a pixel circuit corresponding to one pixel in an image display apparatus according to a second embodiment of the present invention, and FIG. 9B is a timing chart of the pixel circuit;

FIG. 10A is a circuit diagram of a pixel circuit corresponding to one pixel in an image display apparatus according to a third embodiment of the present invention, and FIG. 10B is a timing chart of the pixel circuit;

FIG. 11A is a circuit diagram of a pixel circuit corresponding to one pixel in an image display apparatus according to a fourth embodiment of the present invention, and FIG. 11B is a timing chart of the pixel circuit;

FIG. 12A is a diagram shown to describe a data writing operation in the fourth embodiment, and FIG. 12B is a timing chart of the pixel circuit in the data writing operation;

FIG. 13A is a diagram shown to describe a light emitting operation in the fourth embodiment, and FIG. 13B is a timing chart of the pixel circuit in the light emitting operation;

FIG. 14 is a circuit diagram of a pixel circuit corresponding to one pixel in a conventional image display apparatus; and

FIG. 15 is a graph of a relation between an electric current flowing through a source signal line and an electric current flowing through an OLED in the conventional image display apparatus.

### DETAILED DESCRIPTION OF THE PREFERRED EMBODIMENTS

Exemplary embodiments of an image display apparatus and a method of driving the image display apparatus according to the present invention will be described in detail below with reference to the accompanying drawings. It should be understood that the present invention is not limited to the embodiments.

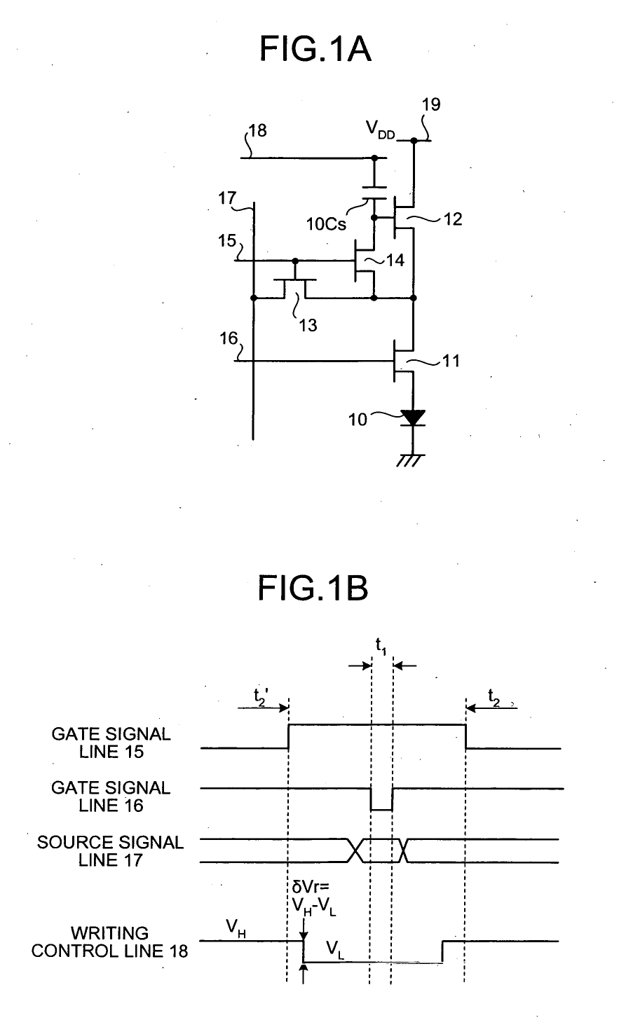

FIG. 1A is a circuit diagram of a pixel circuit corresponding to one pixel in an image display apparatus according to a first embodiment of the present invention, and FIG. 1B is a timing chart of the pixel circuit. The pixel circuit in FIG. 1A includes, an OLED 10, a switching element 11, a driver element 12, a switching element 13, a switching element 14, a gate signal line 15, a gate signal line 16, a source signal line 17, a writing control line 18, an EL power source line 19, and a storage capacitor 10Cs. The switching elements and the driver element, which are for example, transistors as shown in the drawings, are not clearly shown whether each element is an n-type or a p-type. However, they should be interpreted as either n-type or p-type according to the description below.

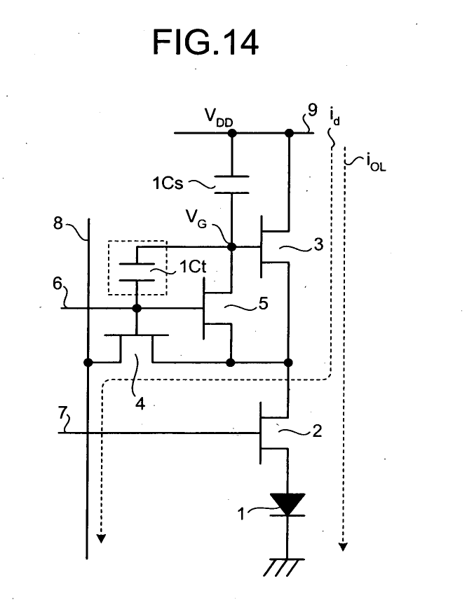

The OLED 10, the switching element 11, the driver element 12, the switching element 13, the switching element 14, the gate signal line 15, the gate signal line 16, the source signal line 17, the EL power source line 19, and the storage capacitor 10Cs in FIG. 1A correspond to the OLED 1, the switching element 2, the driver element 3, the switching element 4, the switching element 5, the gate signal line 6, the gate signal line 7, the source signal line 8, the EL power source line 9, and the storage capacitor 1Cs in FIG. 14, respectively. The switching elements 11, 13, and 14 and the driver element 12 are p-type transistors.

The image display apparatus according to the first embodiment is different from the conventional image display apparatus in that the writing control line 18 is provided and connected to the storage capacitor 10Cs as shown in FIG. 1A.

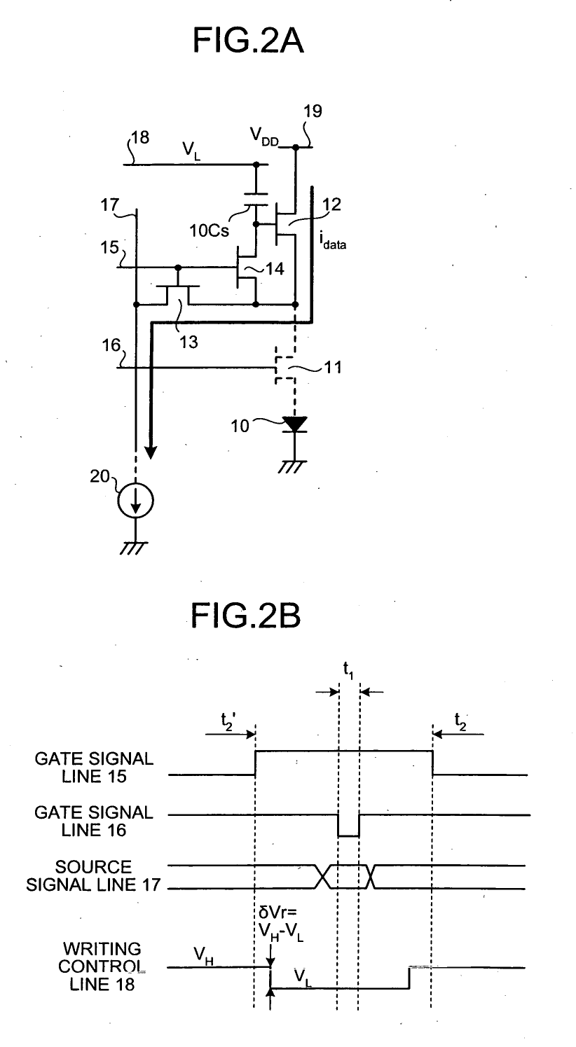

Next, a display in a black level will be described. Following operations are performed under control of a controller (not shown). For the display in the black level, a data writing operation is first performed corresponding to a data writing period t₁ of FIG. 2B. In the data writing period t₁, the potential on the gate signal line 15 is at a high level, the potential on the gate signal line 16 is at a low level, and the potential on the writing control line 18 is at a low level (V_{L})

The switching element 11 is turned OFF as shown in FIG. 2A whereas the switching elements 13 and 14 are turned ON. The gate potential V_{g} of the driver element 12 can be represented by Equation (1):

$${V}_{g} = {V}_{DD} - {V}_{T} - \sqrt{\frac{2 {i}_{data}}{{β}_{L}}} \qquad ( 1 )$$

where V_{DD} is a power source potential applied to the EL power source line 19, V_{T} is a threshold voltage corresponding to a driving threshold of the driver element 12, B_{L} is a value in proportion to carrier mobility in the driver element 12 (hereinafter referred to as a mobility parameter), and i_{data} is an electric data current represented by Equation (2):
i_{data}=α·i_{base} (2)

The mobility parameter β_{L} can be represented by Equation (3):
β_{L}=(W×L)×μ_{eff}×Cₒₓ (3)
where W is a channel width of the driver element 12, which is a transistor such as a Metal Oxide Semiconductor Field Effect Transistor (MOS FET), L is a channel length of the driver element 12, μ_{eff} is a carrier mobility, and Cₒₓ is a capacitance of a gate insulation film.

The electric data current i_{data} represented by Equation (1) flows through a path formed by the EL power source line 19, the driver element 12, the switching element 13, the source signal line 17, and a power source 20 in this order. The electric data current i_{data} is represented by Equation (2) where a is a coefficient, and i_{base} is a black-level electric current.

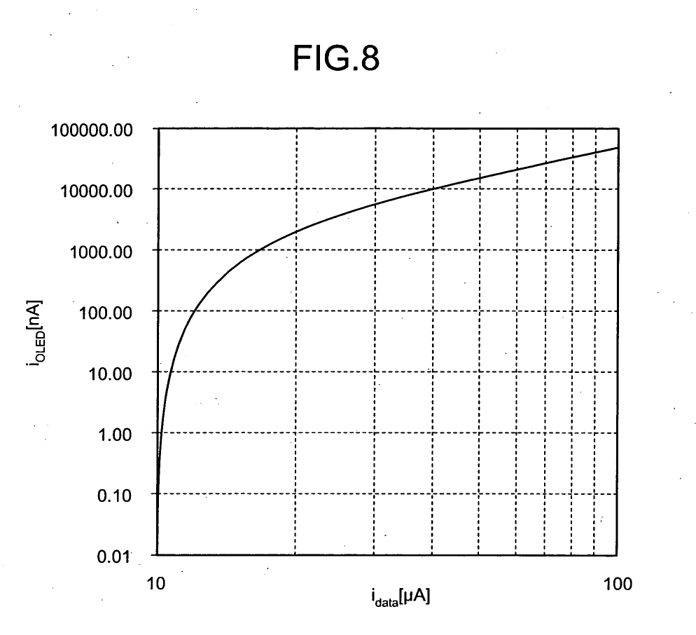

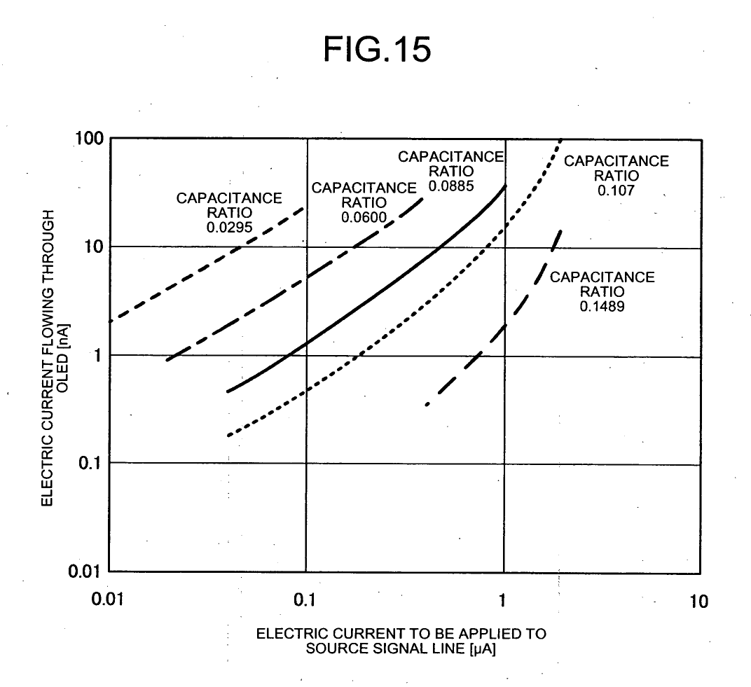

Even if the electric data current i_{data} is made larger, the electric current i_{OLED} flowing through the OLED 10 at the light emission can be maintained at a level for the black level, since the potential on the writing control line 18 at the data writing is lower by an amount of δVᵣ (described later in detail) than the potential on the writing control line 18 at the light emission of the OLED 10 in the previous process. As shown in FIG. 8, for example, in the first embodiment the black level can be maintained even when the amount of i_{data} is set to 10 μA, and the response speed is enhanced to approximately ten times that of the conventional image display apparatus (i_{d}=approximately 1 μA; see FIG. 15).

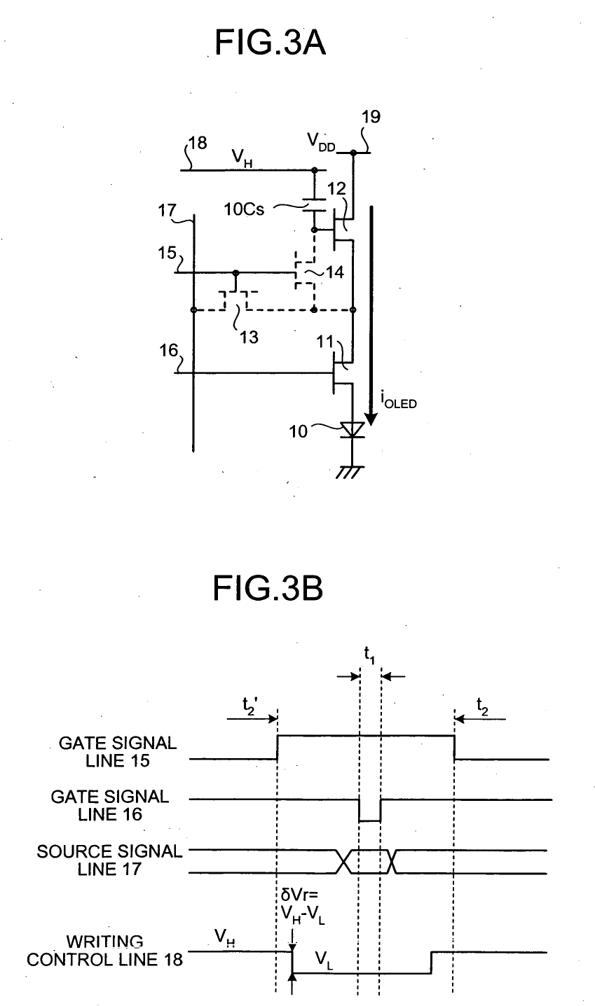

Then, a light emitting operation is performed corresponding to a light emitting period t₂ of FIG. 3B. In the light emitting period t₂, a signal on the gate signal line 15 attains a low level, a potential on the gate signal line 16 is at a high level, a potential on the source signal line 17 is at a high level, and a potential on the writing control line 18 is at a high level (V_{H}). The potential difference δVᵣ on the writing control line 18 is represented by Equation (4):

$$δ {V}_{r} = \sqrt{\frac{2 {i}_{base}}{{β}_{ave}}} \qquad ( 4 )$$

where βₐᵥₑ is an average of the mobility parameter, i.e., an average value of the mobility parameter β_{L} (see Equation (2)) described above, and i_{base} is the black-level electric current as described above.

The value of δVᵣ can be found as follows. The gate potential V_{g} of the driver element 12 at light emission is found from Equation (5):

$${V}_{g} = {V}_{DD} - {V}_{T} - \sqrt{\frac{2 {i}_{data}}{{β}_{L}}} + δ {V}_{r} \qquad ( 5 )$$

For the maintenance of the black level, the gate potential V_{g} needs to be at the level of V_{DD}−V_{T}. Hence, a relation of δVᵣ=(2×i_{data}/β_{L})^{1/2} holds.

Here, since the electric data current i_{data} to be written for the display in the black level is defined as i_{base}, the above expression can be rewritten to another expression δVᵣ=(2×i_{base}/L)^{1/2}. Since the mobility parameter β_{L} is different for each driver element, a most appropriate value of δVᵣ is also different for each pixel. Hence, theoretically it appears to be preferable to connect a separate writing control line 18 to each pixel and to separately assign a different value of δVᵣ for each pixel. Then, however, the circuit structure of the control line 18 and hence, the manner of driving the same become extremely complicated. Thus, preferably the writing control line 18 is shared among pixels which are arranged in a same line or the writing control line 18 is commonly connected to all pixels so that δVᵣ of the same value is assigned to all pixels.

In order to assign the same δVᵣ to all pixels, the value of β_{L} is also required to be same among all pixels. Hence, the mobility parameter β_{L} of each pixel is replaced with βₓ. As a result, a relation (2×i_{base}/βₓ)^{1/2} holds. Preferably the average value βₐᵥₑ of the mobility parameter β is employed as the value of βₐᵥₑ for all pixels as is shown by Equation (4). Alternatively, βₓ may be set in the range of 0.5βₐᵥₑ≦βₓ≦1.5βₐᵥₑ. Still alternatively, βₓ may preferably be set in the range of 0.9βₐᵥₑ≦βₓ≦1.1βₐᵥₑ.

As shown in FIG. 3A, the switching element 11 is turned ON, whereas the switching elements 13 and 14 are turned OFF, and the electric current i_{OLED} represented by Equation (6) flows through a path formed by the EL power source line 19, the driver element 12, the switching element 11, and the OLED 10 in this order.

$$\begin{matrix}{i}_{OLED} = \frac{{β}_{L}}{2} {( {V}_{sg} - {V}_{T} )}^{2} = {( \sqrt{{i}_{data}} - \sqrt{\frac{{β}_{L}}{2}} \cdot δ {V}_{r} )}^{2} \\ = {( \sqrt{{i}_{data}} - \sqrt{\frac{{β}_{L}}{{β}_{ave}} \cdot {i}_{base}} )}^{2} = {{i}_{base} ( \sqrt{α} - \sqrt{\frac{{β}_{L}}{{β}_{ave}}} )}^{2}\end{matrix} \qquad ( 6 )$$

In Equation (6), V_{sg} is a source-to-gate voltage of the driver element 12, V_{T} is a threshold voltage corresponding to a driving threshold of the driver element 12. When α is one and βₐᵥₑ is β_{L} in Equation (6), with the substitution of these values into the last part of Equation (6), the value of the electric current i_{OLED} can be given as zero, which means a display in a perfect black level.

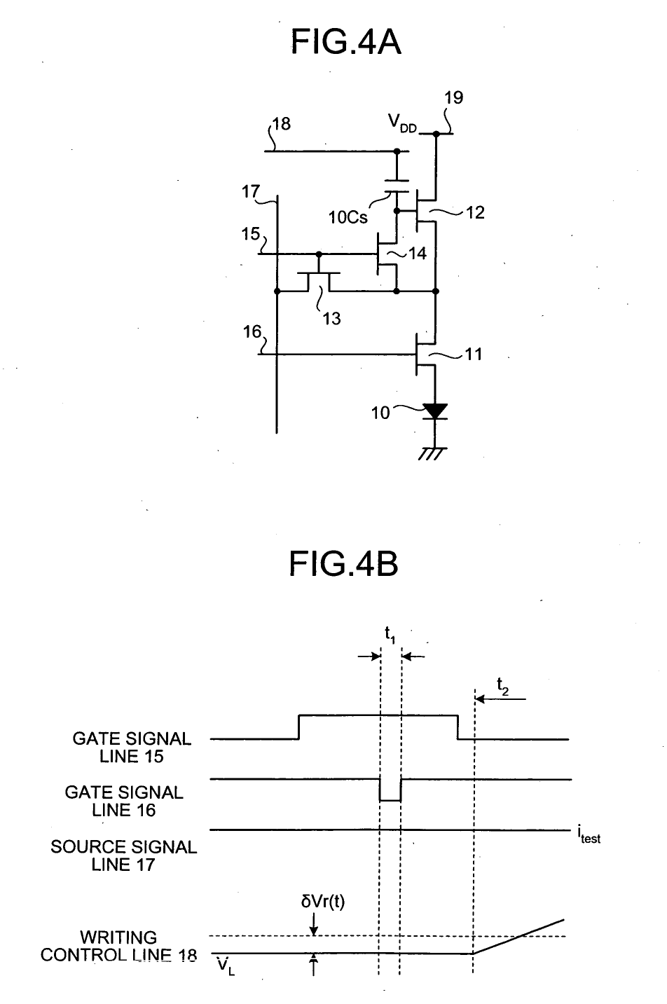

As shown in FIGS. 4A and 4B, the average mobility parameter βₐᵥₑ is found after writing of a test electric current iₜₑₛₜ into all pixel circuits in the image display apparatus, light emission of the OLED 10, temporal changes of potential on the writing control line 18, and the calculation of the mobility parameter in each pixel circuit.

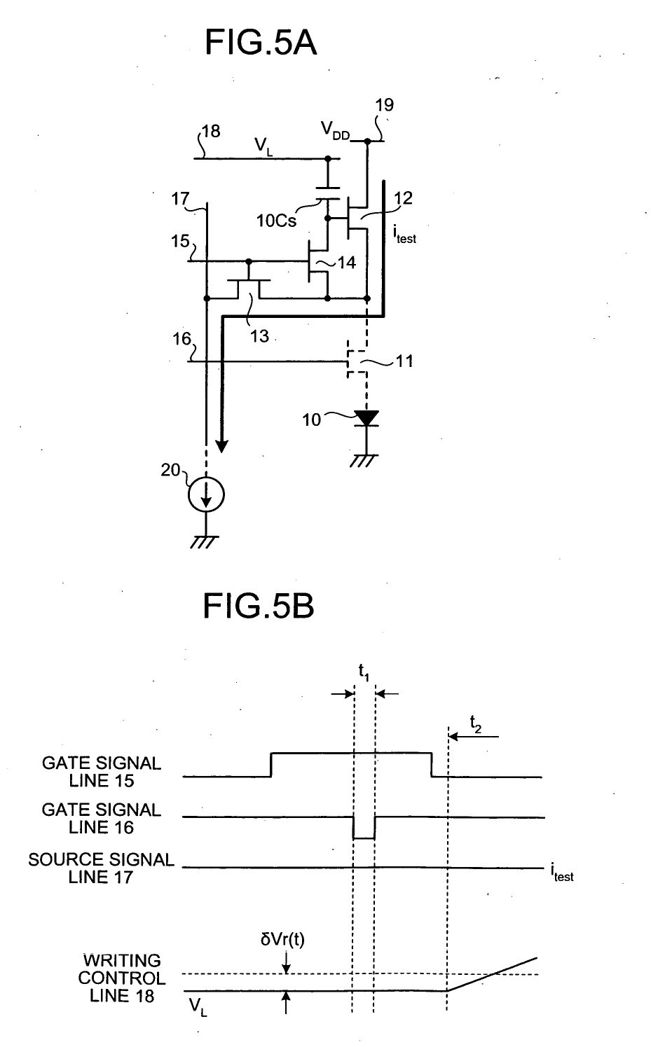

Specifically as shown in FIGS. 5A and 5B, when the switching elements 13 and 14 are turned ON and the switching element 11 is turned OFF, the test electric current iₜₑₛₜ flows through the source signal line 17. Here, the gate potential V_{g} of the driver element 12 can be represented by Equation (7):

$${V}_{g} = {V}_{DD} - {V}_{T} - \sqrt{\frac{2 {i}_{test}}{{β}_{L}}} \qquad ( 7 )$$

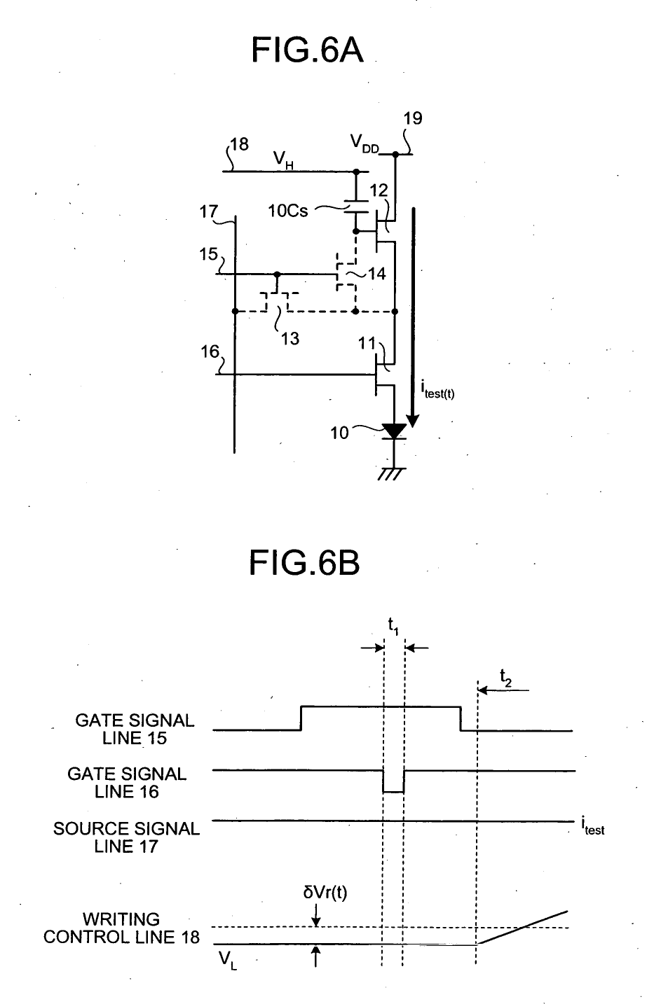

Then, when the switching elements 13 and 14 are turned OFF and the switching element 11 is turned ON as shown in FIGS. 6A and 6B, the test electric current iₜₑₛₜ(t) flows through the OLED 10 to cause light emission of the OLED 10. Here, the gate potential V_{g} of the driver element 12 can be represented by Equation (8):

$${V}_{g} = {V}_{DD} - {V}_{T} - \sqrt{\frac{2 {i}_{test}}{{β}_{L}}} + δ {V}_{r} ( t ) \qquad ( 8 )$$

where iₜₑₛₜ takes a value shown in FIG. 5A.

If, in the light emitting period, the potential difference δVᵣ of the writing control line 18 is changed until the black level is attained at δVᵣ(t) (see Expression (9)), in other words, if the test electric current iₜₑₛₜ(t) represented by Equation (10) is zero (see Equation (11)) and the OLED 10 does not emit light, the mobility parameter β_{L} of the pertinent pixel circuit can be represented by Equation (12) where δVᵣ(t) is a potential difference at an instant the black level is attained.

$$\begin{matrix}δ {V}_{r} ( t ) \geq \sqrt{\frac{2 {i}_{test}}{{β}_{L}}} & ( 9 ) \\ {i}_{test} ( t ) = \frac{{β}_{L}}{2} {( {V}_{sg} - {V}_{T} )}^{2} = {( \sqrt{{i}_{test}} - \sqrt{\frac{{β}_{L}}{2}} \cdot δ {V}_{r} ( t ) )}^{2} & ( 10 ) \\ {i}_{test} ( t ) = 0 & ( 11 ) \\ {β}_{L} = \frac{2 {i}_{test}}{{( δ {V}_{r} ( t ) )}^{2}} & ( 12 )\end{matrix}$$

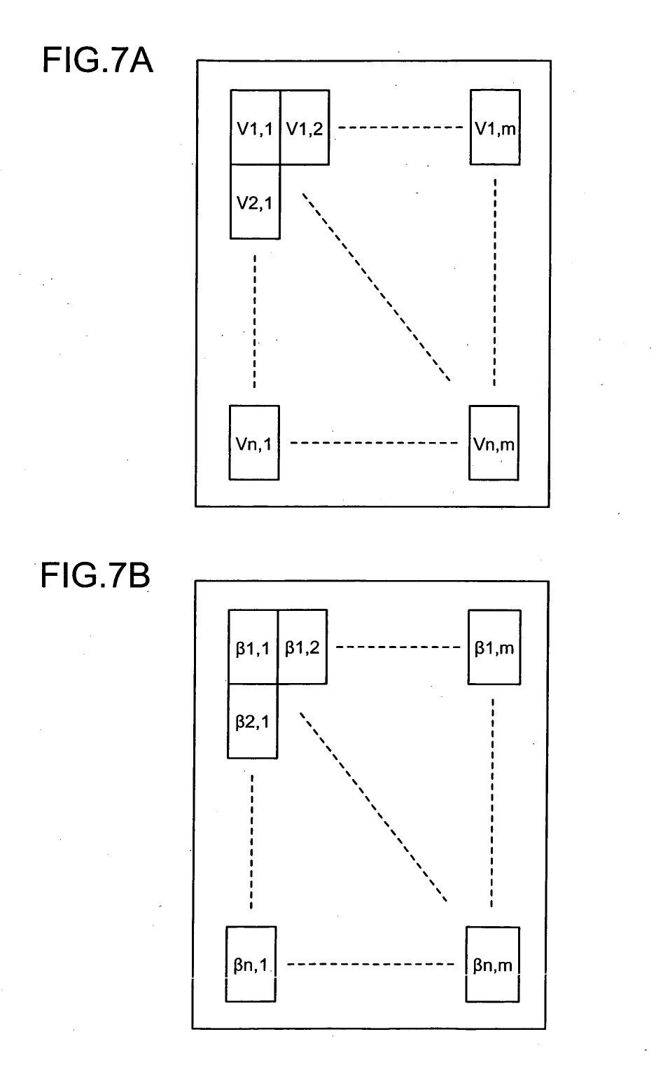

In practice, distribution of potential differences dVᵣ(t) (potential differences V1,1−Vn,m) at the transition to the black level can be obtained for each pixel circuit as shown in FIG. 7A. Then, with the substitution of each value of potential difference (V1,1−Vn,m) and a known value of the test electric current iₜₑₛₜ into δVᵣ(t) of Equation (12), the mobility parameter β_{L} for each pixel circuit is found. Thus, the distribution of the mobility parameter β_{L} can be found for all pixel circuits as shown in FIG. 7B.

Then the average mobility parameter βₐᵥₑ is found based on the distribution of the mobility parameter β_{L}. Specifically, each value (each of β1,1−βn,m) in the distribution of the mobility parameter β_{L} is found and added, and the sum is divided by a number of all pixel circuits (sample number) to provide the average mobility parameter βₐᵥₑ.

As described above, in the first embodiment, the gate potential V_{g} of the driver element 12 is changed via the storage capacitor 10Cs at writing of electric data current for the display in the black level, to increase the amount of electric current i_{data} for the data writing. Thus, unlike the conventional image display apparatus, the response speed at the data writing for the display in the black level can be improved without being affected by the area constraint per pixel.

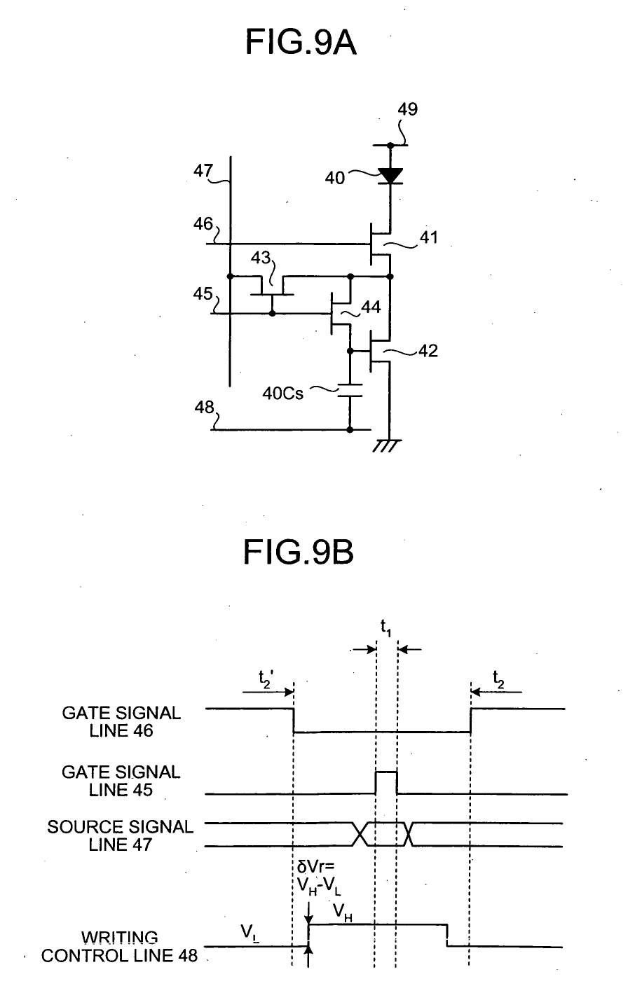

In the description of the first embodiment above, the circuit with the structure of FIG. 1 is described. However, the circuit may take a structure shown in FIG. 9A. Hereinbelow, the exemplary circuit of FIG. 9A will be described as a second embodiment. FIG. 9A is a circuit diagram of a pixel circuit corresponding to one pixel in an image display apparatus according to the second embodiment of the present invention, and FIG. 9B is a timing chart of the pixel circuit. In FIG. 9A, the pixel circuit includes an OLED 40, a switching element 41, a driver element 42, a switching element 43, a switching element 44, a gate signal line 45, a gate signal line 46, a source signal line 47, a writing control line 48, an EL power source line 49, and a storage capacitor 40Cs.

The OLED 40, the switching element 41, the driver element 42, the switching element 43, the switching element 44, the gate signal line 45, the gate signal line 46, the source signal line 47, the writing control line 48, the EL power source line 49, and the storage capacitor 40Cs in FIG. 9 correspond with the OLED 10, the switching element 11, the driver element 12, the switching element 13, the switching element 14, the gate signal line 15, the gate signal line 16, the source signal line 17, the writing control line 18, the EL power source line 19, and the storage capacitor 10Cs in FIG. 1, respectively. The switching elements 41, 43, and 44, and the driver element 42 are n-type transistors.

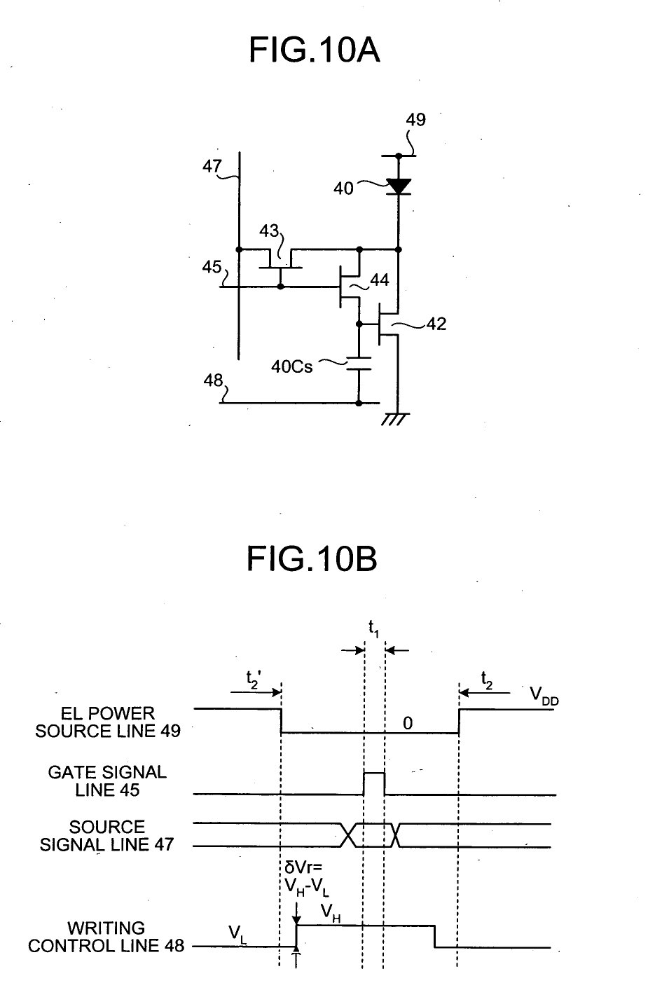

In the description of the second embodiment above, the circuit with the structure of FIG. 9A is described. However, the circuit may take a structure shown in FIG. 10A and its timing chart shown in FIG. 10B where the circuit does not include the switching element 41 and the gate signal line 46 (third embodiment).

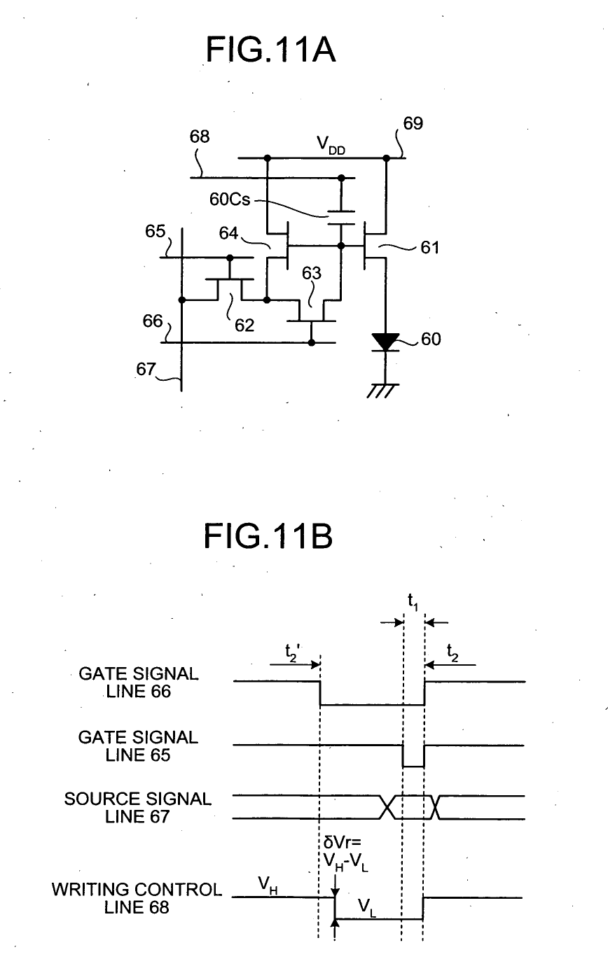

In the description of the first embodiment above, the circuit with the structure of FIG. 1A is described. However, the circuit may take a current-mirror type structure shown in FIG. 11A. The exemplary circuit of FIG. 11A will be described below as a fourth embodiment. FIG. 11A is a circuit diagram of a pixel circuit corresponding to one pixel in an image display apparatus according to the fourth embodiment of the present invention, and FIG. 11B is a timing chart of the pixel circuit. In FIG. 11A, the pixel circuit includes an OLED 60, a driver element 61, a switching element 62, a switching element 63, a driver element 64, a gate signal line 65, a gate signal line 66, a source signal line 67, a writing control line 68, an EL power source line 69, a power source 70, and a storage capacitor 60Cs. The driver elements 61 and 64 form a current mirror circuit. The driver elements 61 and 64, and the switching elements 62 and 63 are p-type transistors.

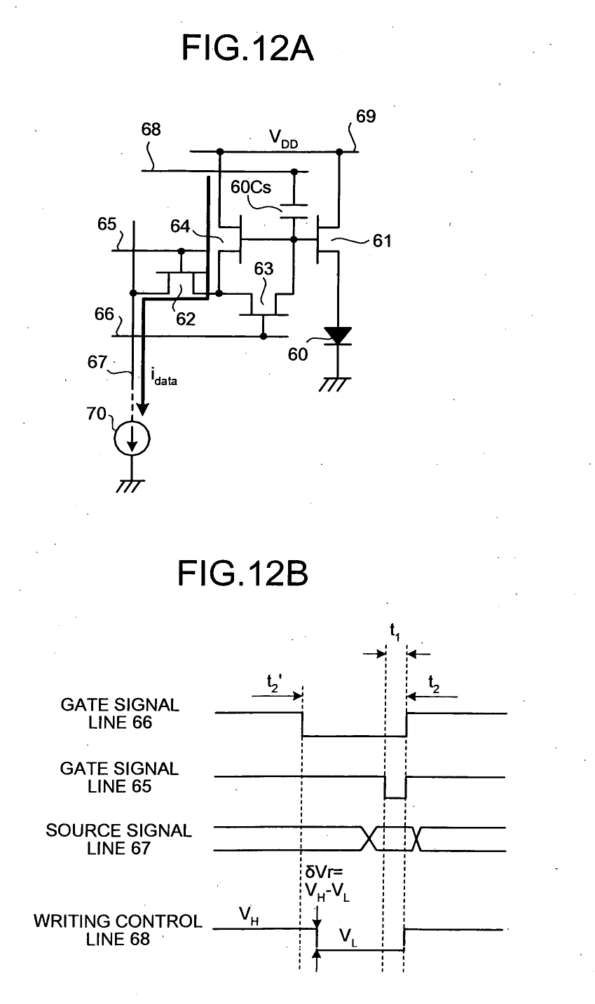

Next, the display in the black level will be described. At the display in the black level, a data writing operation is first performed corresponding to a data writing period t₁ in FIG. 12. In the data writing period t₁, a potential on the gate signal line 66 is at a low level, a potential on the gate signal line 65 is at a low level, and a potential on the writing control line 68 is at a low level (V_{L}).

Then, the gate potential V_{g} of the driver element 64 can be represented by Equation (1) described above. The amount of electric data current i_{data} flowing during this period is represented by Equation (2) described above. Similarly to the first embodiment, the electric data current i_{data} flowing at data writing is as high as 10 μA as shown in FIG. 8.

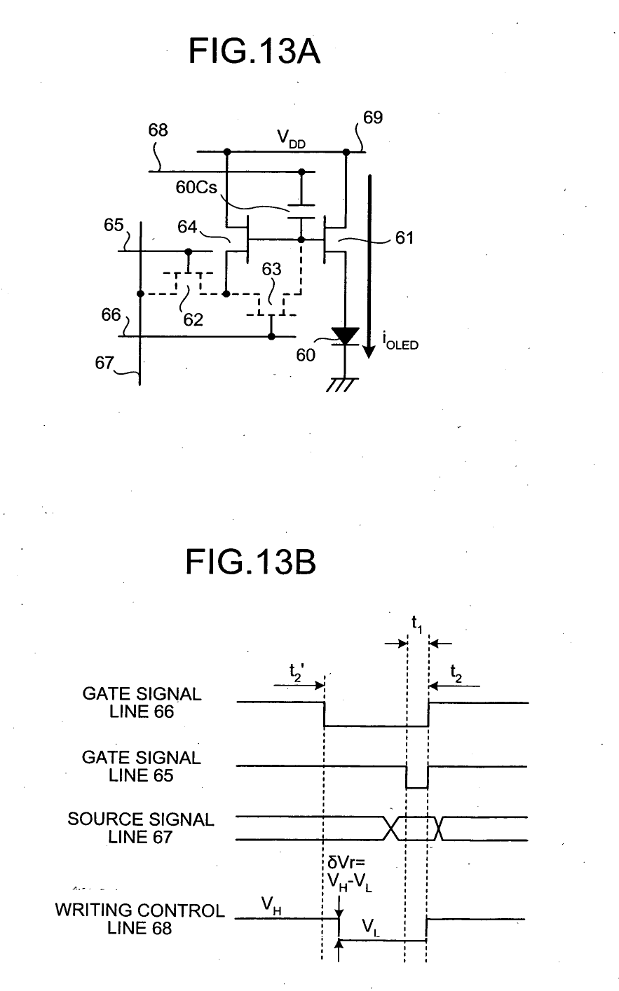

Next, a light emitting operation is performed corresponding to a light emitting period t₂ of FIG. 13B. In the light emitting period t₂, a signal on the gate signal line 66 attains a high level, a potential on the gate signal line 65 is at a high level, a potential on the source signal line 67 is at a high level, and a potential on the writing control line 68 is at a high level (V_{H}). Here the potential difference δVᵣ of the writing control line 68 can be represented by Equation (4) as described above. In addition, the electric current i_{OLED} flowing through the OLED 60 can be represented by Equation (6′):

$$\begin{matrix}{i}_{OLED} = \frac{{κβ}_{L}}{2} {( {V}_{sg} - {V}_{T} )}^{2} = κ {( \sqrt{{i}_{data}} - \sqrt{\frac{{β}_{L}}{2}} \cdot δ {V}_{r} )}^{2} \\ = κ {( \sqrt{{i}_{data}} - \sqrt{\frac{{β}_{L}}{{β}_{ave}} \cdot {i}_{base}} )}^{2} = κ \cdot {{i}_{base} ( \sqrt{α} - \sqrt{\frac{{β}_{L}}{{β}_{ave}}} )}^{2}\end{matrix} \qquad ( 6 ' )$$

Here, κ can be represented as κ=(Wb/Lb)/(Wa/La) where Wa and Wb are channel widths of driver elements 61 and 64, and La and Lb are channel lengths thereof. The gate potential V_{g} of the driver element 61 is represented by Equation (5) as described above.

As can be seen from the foregoing, the image display apparatus according to the present invention is useful for the improvement in the response speed at the display in the black level.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image display apparatus comprising:
a light emitting element that emits light depending on an injected electric current;
a driver that includes at least a first terminal and a second terminal, and controls the light emitting element based on a potential difference, applied between the first terminal and the second terminal, of a level higher than a predetermined threshold;
a storage capacitor that serves to retain a potential on the first terminal of the driver; and
a controller that changes the potential on the first terminal via the storage capacitor at writing of electric data current corresponding to a display in a black level.

2. The image display apparatus according to claim 1, further comprising a writing control line that is connected to one end of the storage capacitor.

3. The image display apparatus according to claim 2,
wherein the controller changes a potential on the writing control line at writing of the electric data current corresponding to the display in the black level, and changes the potential on the first terminal via the storage capacitor, to increase the electric current for data writing.

4. The image display apparatus according to claim 2, wherein the driver is an n-type transistor, and the potential on the writing control line at writing of electric data current corresponding to the display in the black level is higher than a potential on the writing control line at light emission by the light emitting element in a previous process.

5. The image display apparatus according to claim 2, wherein the driver is a p-type transistor, and the potential on the writing control line at writing of electric data current corresponding to the display in the black level is lower than a potential on the writing control line at light emission by the light emitting element in a previous process.

6. The image display apparatus according to claim 2, wherein the writing control line is shared by and connected to pixels in a same line.

7. The image display apparatus according to claim 2, wherein the writing control line is commonly connected to all pixels.

8. The image display apparatus according to claim 2, wherein the writing control line is separately connected to each pixel.

9. The image display apparatus according to claim 2, wherein a potential difference δVᵣ between the potential on the writing control line at light emission by the light emitting element in the previous process and the potential on the writing control line at writing of electric data current corresponding to the display in the black level is substantially same in all pixels.

10. The image display apparatus according to claim 7, wherein the potential difference δVᵣ is represented by an expression (2·i_{base}/0.5ₐᵥₑ)^{1/2}≦δVᵣ≦(2·i_{base}/1.5βₐᵥₑ)^{1/2}, where i_{base} is the amount of electric current applied at the data writing corresponding to the display in the black level, and βₐᵥₑ is an average value of values in proportion to mobility of the driver in each pixel.

11. The image display apparatus according to claim 7 wherein the potential difference δVᵣ is represented by an expression (2·i_{base}/0.9βₐᵥₑ)^{1/2}≦δVᵣ≦(2·i_{base}/1.1βₐᵥₑ)^{1/2}, where i_{base} is the amount of electric current applied at the data writing corresponding to the display in the black level, and βₐᵥₑ is an average value of values in proportion to mobility of the driver in each pixel.

12. The image display apparatus according to claim 8 wherein a potential difference δVᵣ between the potential on the writing control line at light emission of the light emitting element in the previous process and the potential on the writing control line at writing of electric data current corresponding to the display in the black level is different value for each pixel.

13. The image display apparatus according to claim 12, wherein the potential difference δVᵣ is represented by an expression (2·i_{base}/0.5β_{L})^{1/2}≦δVᵣ≦(2·i_{base}/1.5β_{L})^{1/2}, where i_{base} is the amount of electric current applied at the data writing corresponding to the display in the black level, and β_{L} is an average value of values in proportion to mobility of the driver in each pixel.

14. The image display apparatus according to claim 12, wherein the potential difference δVᵣ is represented by an expression (2·i_{base}/0.9 β_{L)}^{1/2}≦δVᵣ≦(2·i_{base}/1.1β_{L})^{1/2}, where i_{base} is the amount of electric current applied at the data writing corresponding to the display in the black level, and β_{L} is an average value of values in proportion to mobility of the driver in each pixel.

15. The image display apparatus according to claim 1, wherein the light emitting element is an organic light-emitting diode.

16. The image display apparatus according to claim 1, wherein the driver is of a current mirror structure.

17. A method of driving an image display apparatus which includes a light emitting element, a driver electrically connected to the light emitting element, and a capacitor having a first electrode and a second electrode which is connected to a gate of the driver, the method comprising:
controlling a potential on the gate by changing a potential on the first electrode of the capacitor at writing of electric data current corresponding to a display in a black level.

18. The method according to claim 17, wherein the driver is an n-type transistor, and the potential on the first electrode of the capacitor at writing of electric data current corresponding to the display in the black level is higher than a potential on the first electrode of the capacitor at light emission by the light emitting element in a previous process.

19. The method according to claim 17, wherein the driver is a p-type transistor, and the potential on the first electrode of the capacitor at writing of electric data current corresponding to the display in the black level is lower than a potential on the first electrode of the capacitor at light emission by the light emitting element in a previous process.

20. The method according to claim 17, wherein the light emitting element is an organic light-emitting diode.
